(19) United States
(12) Patent Application Publication
(10) Pub. No.: US 2024/0199987 A1
(43) Pub. Date: Jun. 20, 2024

(54) FABRIC CONDITIONER COMPOSITIONS

(71) Applicant: Conopco, Inc., d/b/a UNILEVER, Englewood Cliffs, NJ (US)

(72) Inventors: Rafael Tassiro CACHIBA, Itapira-SP (BR); Helen Cristiane CAMARGO, Vinhedo-SP (BR); Nicholas Eamonn PAGE, St Helens (GB); Andrew Peter ROSE, Wirral (GB)

(73) Assignee: Conopco, Inc., d/b/a UNILEVER, Englewood Cliffs, NJ (US)

(21) Appl. No.: 18/286,159

(22) PCT Filed: Apr. 11, 2022
(86) PCT No.: PCT/EP2022/059657

§ 371 Date: Oct. 9, 2023

(30) Foreign Application Priority Data
Apr. 14, 2021 (EP) 21168283.6

(51) Int. Cl. C11D 3/00; C11D 1/62; C11D 3/20; C11D 3/37; C11D 3/50

(52) U.S. Cl. CPC C11D 3/001; C11D 1/62; C11D 3/0036; C11D 3/2013; C11D 3/3715; C11D 3/505; C11D 2111/12

(57) ABSTRACT

A fabric conditioner formulation comprising a) 2 to 7.5 wt. % fabric softening active: and b) soil release polymer.

### FIELD OF THE INVENTION

The present invention relates to the delivery of soil release polymers to fabrics.

### BACKGROUND OF THE INVENTION

Fabric conditioners traditionally provide softening and fragrance to fabrics, while cleaning benefits are delivered from a laundry detergent. This is in part due to the differences in the compositions of fabric conditioners and detergents, and in part due to the fact that detergents and conditioners are added at different times in the laundry cycle. Laundry detergents are added in the wash cycle which is normally significantly longer than the rinse cycle where the fabric conditioner is delivered. Despite these differences there is a desire from consumers for fabric conditioners to deliver additional benefits on top of softening and fragrance. Such benefits may be delivered by a soil release polymer.

It has surprisingly been found that a specific quantity of fabric softening active leads to superior performance of a soil release polymer, in particular preventing soil deposition on fabrics.

### SUMMARY OF THE INVENTION

In a first aspect of the present invention is provided a fabric conditioner formulation comprising:
a. 2 to 7.5 wt. % fabric softening active;
b. Soil release polymer;
c. Perfume microcapsules; and
d. Fatty complexing agent.

In a second aspect of the present invention is provided a method of protecting fabrics from permanent staining, wherein the method comprises the steps of:
i. Treating the fabric with a composition as described here in the rinse stage of a laundry process;
ii. Using the fabric; and
iii. Washing the fabric with a laundry detergent.

In a third aspect of the present invention is provided a use of a soil release polymer in a fabric conditioner as described herein to provide; colour care, maintaining whites, stain protection or a combination thereof.

### DETAILED DESCRIPTION

These and other aspects, features and advantages will become apparent to those of ordinary skill in the art from a reading of the following detailed description and the appended claims. For the avoidance of doubt, any feature of one aspect of the present invention may be utilised in any other aspect of the invention. The word “comprising” is intended to mean “including” but not necessarily “consisting of” or “composed of.” In other words, the listed steps or options need not be exhaustive. It is noted that the examples given in the description below are intended to clarify the invention and are not intended to limit the invention to those examples per se. Similarly, all percentages are weight/weight percentages unless otherwise indicated. Except in the operating and comparative examples, or where otherwise explicitly indicated, all numbers in this description indicating amounts of material or conditions of reaction, physical properties of materials and/or use are to be understood as modified by the word “about”. Numerical ranges expressed in the format “from x to y” are understood to include x and y. When for a specific feature multiple preferred ranges are described in the format “from x to y”, it is understood that all ranges combining the different endpoints are also contemplated.

As used herein “the laundry process” or the “laundry cycle” refers to the combination of all stages of the laundry process. A single laundry cycle generally comprises: washing, rinsing, drying and using the fabrics, after which the cycle is repeated.

### Fabric Softening Active

The fabric conditioners of the present invention comprise fabric softening actives. The fabric softening actives may be any material known to soften fabrics. These may be polymeric materials or compounds known to soften materials. Examples of suitable fabric softening actives include: quaternary ammonium compounds, silicone polymers, polysaccharides, clays, amines, fatty esters, dispersible polyolefins, polymer latexes and mixtures thereof.

The fabric softening actives may preferably be cationic or non-ionic materials. Preferably, the fabric softening actives of the present invention are cationic materials. Suitable cationic fabric softening actives are described herein.

The preferred softening actives for use in fabric conditioner compositions of the invention are quaternary ammonium compounds (QAC).

The QAC preferably comprises at least one chain derived from fatty acids, more preferably at least two chains derived from a fatty acids. Generally fatty acids are defined as aliphatic monocarboxylic acids having a chain of 4 to 28 carbons. Fatty acids may be derived from various sources such as tallow or plant sources. Preferably the fatty acid chains are derived from plants. Preferably the fatty acid chains of the QAC comprise from 10 to 50 wt. % of saturated C18 chains and from 5 to 40 wt. % of monounsaturated C18 chains by weight of total fatty acid chains. In a further preferred embodiment, the fatty acid chains of the QAC comprise from 20 to 40 wt. %, preferably from 25 to 35 wt. % of saturated C18 chains and from 10 to 35 wt. %, preferably from 15 to 30 wt. % of monounsaturated C18 chains, by weight of total fatty acid chains.

The preferred quaternary ammonium fabric softening actives for use in compositions of the present invention are so called “ester quats” or ester linked quaternary ammonium compounds. Particularly preferred materials are the ester-linked triethanolamine (TEA) quaternary ammonium compounds comprising a mixture of mono-, di- and tri-ester linked components.

Typically, TEA-based fabric softening compounds comprise a mixture of mono, di- and tri ester forms of the compound where the di-ester linked component comprises no more than 70 wt. % of the fabric softening compound, preferably no more than 60 wt. % e.g. no more than 55%, or even no more that 45% of the fabric softening compound and at least 10 wt. % of the monoester linked component.

A first group of quaternary ammonium compounds (QACs) suitable for use in the present invention is represented by formula (I):

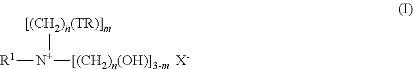

wherein each R is independently selected from a C5 to C35 alkyl or alkenyl group; R1 represents a C1 to C4 alkyl, C2 to C4 alkenyl or a C1 to C4 hydroxyalkyl group; T may be either O—CO. (i.e. an ester group bound to R via its carbon atom), or may alternatively be CO—O (i.e. an ester group bound to R via its oxygen atom); n is a number selected from 1 to 4; m is a number selected from 1, 2, or 3; and X— is an anionic counter-ion, such as a halide or alkyl sulphate, e.g. chloride or methylsulfate. Di-esters variants of formula I (i.e. m=2) are preferred and typically have mono- and tri-ester analogues associated with them. Such materials are particularly suitable for use in the present invention.

Suitable actives include soft quaternary ammonium actives such as Stepantex VT90, Rewoquat WE18 (ex-Evonik) and Tetranyl L1/90N, Tetranyl L190 SP and Tetranyl L190 S (all ex-Kao).

Also suitable are actives rich in the di-esters of triethanolammonium methylsulfate, otherwise referred to as “TEA ester quats”.

Commercial examples include Preapagen™ TQL (ex-Clariant), and Tetranyl™ AHT-1 (ex-Kao), (both di-[hardened tallow ester] of triethanolammonium methylsulfate), AT-1 (di-[tallow ester] of triethanolammonium methy|sulfate), and L5/90 (di-[palm ester] of triethanolammonium methylsulfate), (both ex-Kao), and Rewoquat™ WE15 (a di-ester of triethanolammonium methylsulfate having fatty acyl residues deriving from C10-C20 and C16-C18 unsaturated fatty acids) (ex-Evonik).

A second group of QACs suitable for use in the invention is represented by formula (II):

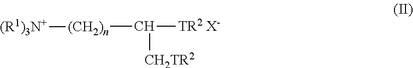

wherein each R1 group is independently selected from C1 to C4 alkyl, hydroxyalkyl or C2 to C4 alkenyl groups; and wherein each R2 group is independently selected from C8 to C28 alkyl or alkenyl groups; and wherein n, T, and X— are as defined above.

Preferred materials of this second group include 1,2 bis[tallowoyloxy]-3-trimethylammonium propane chloride, 1,2 bis[hardened tallowoyloxy]-3-trimethylammonium propane chloride, 1,2-bis[oleoyloxy]-3-trimethylammonium propane chloride, and 1,2 bis[stearoyloxy]-3-trimethylammonium propane chloride. Such materials are described in U.S. Pat. No. 4,137,180 (Lever Brothers). Preferably, these materials also comprise an amount of the corresponding mono-ester.

A third group of QACs suitable for use in the invention is represented by formula (III):

(R¹)₂—N⁺—[(CH₂)ₙ—T—R²]₂X⁻ (III)

wherein each R1 group is independently selected from C1 to C4 alkyl, or C2 to C4 alkenyl groups; and wherein each R2 group is independently selected from C8 to C28 alkyl or alkenyl groups; and n, T, and X— are as defined above. Preferred materials of this third group include bis(2-tallowoyloxyethyl)dimethyl ammonium chloride, partially hardened and hardened versions thereof.

A particular example of the fourth group of QACs is represented the by the formula (IV):

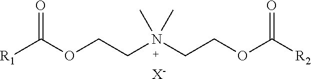

A fourth group of QACs suitable for use in the invention are represented by formula (V)

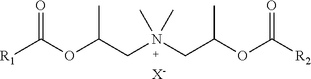

R1 and R2 are independently selected from C10 to C22 alkyl or alkenyl groups, preferably C14 to C20 alkyl or alkenyl groups. X— is as defined above.

The iodine value of the quaternary ammonium fabric conditioning material is preferably from 0 to 80, more preferably from 0 to 60, and most preferably from 0 to 45. The iodine value may be chosen as appropriate. Essentially saturated material having an iodine value of from 0 to 5, preferably from 0 to 1 may be used in the compositions of the invention. Such materials are known as “hardened” quaternary ammonium compounds.

A further preferred range of iodine values is from 20 to 60, preferably 25 to 50, more preferably from 30 to 45. A material of this type is a “soft” triethanolamine quaternary ammonium compound, preferably triethanolamine di-alkylester methylsulfate. Such ester-linked triethanolamine quaternary ammonium compounds comprise unsaturated fatty chains.

If there is a mixture of quaternary ammonium materials present in the composition, the iodine value, referred to above, represents the mean iodine value of the parent fatty acyl compounds or fatty acids of all the quaternary ammonium materials present. Likewise, if there are any saturated quaternary ammonium materials present in the composition, the iodine value represents the mean iodine value of the parent acyl compounds of fatty acids of all of the quaternary ammonium materials present.

Iodine value as used in the context of the present invention refers to, the fatty acid used to produce the QAC, the measurement of the degree of unsaturation present in a material by a method of nmr spectroscopy as described in Anal. Chem. , 34, 1136 (1962) Johnson and Shoolery.

A further type of softening compound may be a non-ester quaternary ammonium material represented by formula (VI):

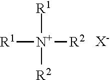

wherein each R1 group is independently selected from C1 to C4 alkyl, hydroxyalkyl or C2 to C4 alkenyl groups; R2 group is independently selected from C8 to C28 alkyl or alkenyl groups, and X— is as defined above.

The fabric conditioners of the present invention comprise more than 2 wt. % fabric softening active, more preferably more than 3 wt. % fabric softening active, most preferably more than 4 wt. % fabric softening active by weight of the composition. The fabric conditioners of the present invention comprise less than 7.5 wt. % fabric softening active, more preferably less than 7 wt. % fabric softening active. Suitably the fabric conditioners comprise 2 to 7.5 wt. % fabric softening active, preferably 3 to 7.5 wt. % fabric softening active and more preferably 4 to 7 wt. % fabric softening active by weight of the composition.

Without wishing to be bound by theory it is believed that this level of fabric softening active, preferably a quaternary ammonium fabric softening active, most preferably an ester linked quaternary ammonium fabric softening active, leads to enhanced benefits from the soil release polymer.

### Soil Release Polymers

The fabric conditioners described herein comprise a soil release polymer (SRP). SRPs for use in the present invention may include a variety of charged (e.g. anionic) as well as non-charged monomer units. The structures may be linear, branched or star-shaped. The SRP structure may also include capping groups to control molecular weight or to alter polymer properties such as surface activity.

The weight average molecular weight of the polymeric soil release polymer may be at least 1,000, at least 2,000, at least 5,000, at least 10,000, at least 15,000, at least 20,000 or at least 25,000. The upper limit for the weight average molecular weight may be, for example, 100,000; 75,000; 60,000; 55,000; 50,000; 40,000 or 30,000. For example, the weight average molecular weight may be between about 5,000 to about 50,000, such as between about 1,200 to 12,000.

SRPs for use in the present invention may be selected from copolyesters of dicarboxylic acids (for example adipic acid, phthalic acid or terephthalic acid), diols (for example ethylene glycol or propylene glycol) and polydiols (for example polyethylene glycol or polypropylene glycol). The copolyester may also include monomeric units substituted with anionic groups, such as for example sulfonated isophthaloyl units. Examples of such materials include oligomeric esters produced by transesterification/oligomerization of poly(ethyleneglycol) methyl ether, dimethyl terephthalate (“DMT”), propylene glycol (“PG”) and poly(ethyleneglycol) (“PEG”); partly- and fully-anionic-end-capped oligomeric esters such as oligomers from ethylene glycol (“EG”), PG, DMT and Na-3,6-dioxa-8-hydroxyoctanesulfonate; nonionic-capped block polyester oligomeric compounds such as those produced from DMT, Me-capped PEG and EG and/or PG, or a combination of DMT, EG and/or PG, Me-capped PEG and Na-dimethyl-5-sulfoisophthalate, and copolymeric blocks of ethylene terephthalate or propylene terephthalate with polyethylene oxide or polypropylene oxide terephthalate.

Other types of SRP for use in the invention include cellulosic derivatives such as hydroxyether cellulosic polymers, C₁-C₄ alkylcelluloses and C₄ hydroxyalkyl celluloses; polymers with poly(vinyl ester) hydrophobic segments such as graft copolymers of poly(vinyl ester), for example C₁-C₆ vinyl esters (such as poly(vinyl acetate)) grafted onto polyalkylene oxide backbones; poly(vinyl caprolactam) and related co-polymers with monomers such as vinyl pyrrolidone and/or dimethylaminoethyl methacrylate; and polyester-polyamide polymers prepared by condensing adipic acid, caprolactam, and polyethylene glycol.

A first example of suitable soil release polymers are those according to the following generic formula:

X₁—R₁—Z—R₂—X₂ Formula (V)

Wherein:
X₁ and X₂ are independently capping moieties
R₁ and R₁ are independently one or more nonionic hydrophilic blocks
Z is one or more anionic hydrophobic blocks
X₁ and X₂ are independently, preferably, alkyl groups, more preferably C₁₋₄ alkyl branched or unbranched moieties.
R₁ and R₁ are independently, preferably blocks consisting of one or more nonionic hydrophilic components selected from:
   (i) polyoxyethylene segments with a degree of polymerization of at least 2, preferably from 3 to about 150, more preferably from 6 to about 100 or
   (ii) polyoxypropylene segments with a degree of polymerization of at least 2, or
   (iii) oxypropylene or polyoxypropylene segments with a degree of polymerization of from 2 to 10, wherein said hydrophile segment does not encompass any oxypropylene unit unless it is bonded to adjacent moieties at each end by ether linkages, or
   (iv) a mixture of oxyalkylene units comprising oxyethylene and from 1 to about 30 oxypropylene units wherein said mixture contains a sufficient amount of oxyethylene units such that the hydrophile component has hydrophilicity great enough to increase the hydrophilicity of conventional polyester synthetic fiber surfaces upon deposit of the soil release agent on such surface, said hydrophile segments preferably comprising at least about 25% oxyethylene units and more preferably, especially for such components having about 20 to 30 oxypropylene units, at least about 50% oxyethylene units; or
   (v) oxypropylene and/or polyoxypropylene segments in the terminal positions of the polymer chain.
Z preferably consists of one or more anionic hydrophobic components selected from:
   (i) C3 oxyalkylene terephthalate segments, wherein, if said hydrophobe components also comprise oxyethylene terephthalate, the ratio of oxyethylene terephthalate:C3 oxyalkylene terephthalate units is about 2:1 or lower, where the terephthalate segments are at least partially sulphonated
   ii) C4-C6 alkylene or oxy C4-C6 alkylene segments, or mixtures therein, preferably these segments include, but are not limited to, end-caps of polymeric soil release agents such as MO3 S(CH2)n OCH2 CH2 O—, where M is sodium and n is an integer from 4-6, as disclosed in U.S. Pat. No. 4,721,580, issued Jan. 26, 1988 to Gosselink.,
   (iii) poly (vinyl ester) segments, preferably polyvinyl acetate), having a degree of polymerization of at least 2, or (iv) C1-C4 alkyl ether or C4 hydroxyalkyl ether substituents, or mixtures therein, wherein said substituents are present in the form of C1-C4 alkyl ether or C4 hydroxyalkyl ether cellulose derivatives, or mixtures therein, and such cellulose derivatives are amphiphilic, whereby they have a sufficient level of C1-C4 alkyl ether and/or C4 hydroxyalkyl ether units to deposit upon conventional polyester synthetic fiber surfaces and retain a sufficient level of hydroxyls, once adhered to such conventional synthetic fiber surface, to increase fiber surface hydrophilicity, or a combination of (a) and (b). preferably these segements include graft copolymers of poly(vinyl ester), e.g., C1-C6 vinyl esters, preferably poly(vinyl acetate) grafted onto polyalkylene oxide backbones, such as polyethylene oxide backbones. See European Patent Application 0 219 048, published Apr. 22, 1987 by Kud, et al. Commercially available soil release agents of this kind include the SOKALAN type of material, e.g., SOKALAN HP-22, available from BASF (West Germany).
   (iv) isophthalate groups, such as a 1, 4-phenylene moiety or a 1, 3-phenylene moiety having 0 to 4 anionic substituents (such as carboxylate, phosphonate, phosphate or, preferably sulphonate), preferably 1, 4-phenylene moiety having 0 to 4 anionic substituents.
Preferably, the Z is a polyester polymer or comprises a polyester copolymer region.

A second example of suitable soil release polymers are polymers which are a sulfonated product of a substantially linear ester oligomer comprised of an oligomeric ester backbone of terephthaloyl and oxyalkyleneoxy repeat units and terminal moieties covalently attached to the backbone. These soil release agents are described fully in U.S. Pat. No. 4,968,451, issued Nov. 6, 1990 to J.J. Scheibel and E. P. Gosselink. Other suitable polymeric soil release agents include the terephthalate polyesters of U.S. Pat. No. 4,711,730, issued Dec. 8, 1987 to Gosselink et al, the anionic end-capped oligomeric esters of U.S. Pat. No. 4,721,580, issued Jan. 26, 1988 to Gosselink, and the block polyester oligomeric compounds of U.S. Pat. No. 4,702,857, issued Oct. 27, 1987 to Gosselink.

A third example of suitable soil release polymers are polymers which are an oligomer with repeat units of terephthaloyl units, sulfoisoterephthaloyl units, oxyethyleneoxy and oxy-1,2-propylene units. The repeat units form the backbone of the oligomer and are preferably terminated with modified isethionate end-caps. A particularly preferred soil release agent of this type comprises about one sulfoisophthaloyl unit, 5 terephthaloyl units, oxyethyleneoxy and oxy-1,2-propyleneoxy units in a ratio of from about 1.7 to about 1.8, and two end-cap units of sodium 2-(2-hydroxyethoxy)-ethanesulfonate. Said soil release agent also comprises from about 0.5% to about 20%, by weight of the oligomer, of a crystalline-reducing stabilizer, preferably selected from the group consisting of xylene sulfonate, cumene sulfonate, toluene sulfonate, and mixtures thereof.

A fourth example of suitable soil release polymers polyester polymers with repeat units of ethylene terephthalate units contains 10-15% by weight of ethylene terephthalate units together with 90-80% by weight of polyoxyethylene terephthalate units, derived from a polyoxyethylene glycol of average molecular weight 300-5,000. Examples of this polymer include the commercially available material ZELCON 5126 (from DuPont) and MILEASE T (from ICI). See also U.S. Pat. No. 4,702,857, issued Oct. 27, 1987 to Gosselink. Further examples of soil release polymers are terephthalic acid/glycol copolymers sold under the tradenames Texcare®, Repel-o-tex®, Gerol®, Marloquest® and, Cirrasol®.

A fifth example of suitable soil release polymers are polymers which comprise copolymers having random blocks of ethylene terephthalate and polyethylene oxide (PEO) terephthalate. The molecular weight of this polymeric soil release agent is in the range of from about 25,000 to about 55,000. See U.S. Pat. No. 3,959,230 to Hays, issued May 25, 1976 and U.S. Pat. No. 3,893,929 to Basadur issued Jul. 8, 1975.

A sixth example of suitable soil release polymers are polymers according to the following formula (VI):

X-[(EO)_{q1}-block-(PO)ₚ]-[(A-G₁-A-G₂)n]-B-G₁-B-[(PO)ₚ-block-(EO)_{q2}]-X Formula (VI)

wherein EO is ethylene oxide (CH2CH2O ) and PO is at least 80 wt. % propylene oxide (CH2CH(CH3)O), and preferably 100% PO units;
where p is a number from 0 to 60, and when p is not zero is preferably from 2 to 50, more preferably from 5 to 45, even more preferably from 6 to 40, yet more preferably from 7 to 40 and most preferably from 8 to 40, even from 11 to 35;
where q1 and q2 is a number from 6 to 120, preferably 18 to 80, most preferably 40 to 70, provided that q2 is greater than p and preferably q2 is at least 1.5 times as large as p;
where n is a number from 2 to 26; preferably 5 to 15;
Because they are an average, n, p, q1 and q2 are not necessarily a whole number for the polymer in bulk.
where X is a capping moiety, preferably selected from C1-4 alkyl, branched and unbranched;
A and B are selected from ester, amide and urethane moieties, preferably the moieties A and B nearest to any PO blocks are esters, A and B may be different or may be the same;
when the moieties A and B adjacent to the PO blocks are esters then it is preferred that p is not zero,
alternatively, it is preferred that the ratio of (q1+q2):n is from 4 to 10 and that q2 is from 40 to 120;
G1 comprises 1,4 phenylene;
G2 is ethylene, which may be substituted;

It is preferred that moieties G2 are all ethylene of formula (VII)

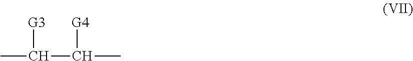

wherein G3 and G4 are selected from Hydrogen, C1-4 alkyl and C1-4 alkoxy, provided that at least one of G3 and G4 is not hydrogen and that at least 10% of the groups G2 have neither G3 nor G4 as hydrogen. Preferably when G3 and G4 are not hydrogen then they are methyl moieties. Preferably the non H substituents, more preferably the methyl moieties, are arranged in syn configuration on the ethylene backbone —CH—CH—of moieties G2.

A preferred class of SRP for use in the invention include copolyesters formed by condensation of terephthalic acid ester and diol, preferably 1,2 propanediol, and further comprising an end cap formed from repeat units of alkylene oxide capped with an alkyl group. Examples of such materials have a structure corresponding to general formula is a soil release polymer may be according to the following formula (VIII):

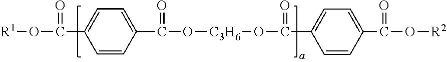

wherein
R¹ and R² independently of one another are X—(OC₂H₄)ₙ—(OC₃H₆)ₘ wherein the —(OC₂H₄) groups and the —(OC₃H₆) groups are arranged blockwise and the block consisting of the —(OC₃H₆) groups is bound to a COO group or are HO—(C₃H₆), preferably independently of one another are H₃C—(OC₂H₄)ₙ—(OC₃H₆)ₘ wherein the —(OC₂H₄) groups and the —(OC₃H₆) groups are arranged blockwise and the block consisting of the —(OC₃H₆) groups is bound to a COO group,
X is C₁₋₄ alkyl, preferably methyl,
n is based on a molar average a number of from 12 to 120
m is based on a molar average a number of from 1 to 10
a is based on a molar average a number of from 4 to 9,

Because they are averages, m, n and a are not necessarily whole numbers for the polymer in bulk.

In the polymer of formula (VIII), “X” of R¹ and R² is preferably methyl.

In the polymer of formula (VIII), the —(OC₃H₆) groups of R¹ and R² is preferably bound to a COO group.

In the polymer of formula (VIII), the variable “n” based on a molar average preferably is a number of from 40 to 50, more preferably is a number of from 43 to 47 and even more preferably is 44 to 46 and most preferably 45.

In the polymer of formula (VIII), the variable “m” based on a molar average preferably is a number of from 1 to 7, more preferably a number from 2 to 6.

In the polymer of formula (VIII), the variable “a” based on a molar average preferably is a number of from 5 to 8 and more preferably is a number of from 6 to 7.

The groups —O—C₂H₄—in the structural units “X—(OC₂H₄)ₙ—(OC₃H₆)ₘ” or “H₃C—(OC₂H₄)ₙ—(OC₃H₆)ₘ” are of the formula —O—CH₂—CH₂—.

The groups —O—C₃H₆—in the structural units indexed with “a”, in the structural units “X—(OC₂H₄)ₙ—(OC₃H₆)ₘ” or “H₃C—(OC₂H₄)ₙ—(OC₃H₆)ₘ” and in the structural units HO—(C₃H₆) are of the formula —O—CH(CH₃)—CH₂—or —O—CH₂—CH(CH₃)—, i.e. are of the formula

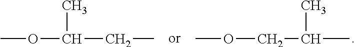

Preferably these polymers comprise aromatic dicarboxylic acids and alkylene glycols (including polymers containing polyalkylene glycols). More preferably, the anionic soil release polymer is formed from aromatic dicarboxylic acid/ester and alkylene glycol units (including polymers containing polyalkylene glycols), such as those described in US 2013/0200290. Examples of suitable polymers include Texcare® SRA 100N or Texcare® SRA 300F marketed by Clariant®.

Mixtures of any of the above described materials may also be used.

The fabric conditioner compositions of the present invention comprise 0.05 to 5 wt. % soil release polymer, by weight of the composition. Preferably the compositions comprise more than 0.1 wt. %, more preferably more than 0.2 wt. % soil release polymer by weight of the composition. Preferably the compositions comprise less than 3.5 wt. %, more preferably less than 2 wt. % soil release polymer, by weight of the composition. Preferably the compositions comprise 0.1 to 3.5 wt. % soil release polymer and more preferably 0.2 to 2 wt. % soil release polymer.

The inclusion of the soil release polymer provides various benefits. These may be demonstrated by parity compared to a detergent or an improvement in colour care, maintaining whites, stain protection.

### Perfumes

The fabric conditioner compositions of the present invention comprise perfume microcapsules.

The fabric conditioner compositions of the present invention preferably comprise perfume materials, in particular 0.05 to 20 wt. % perfume materials, i.e. free perfume and/or perfume microcapsules. As is known in the art, free perfumes and perfume microcapsules provide the consumer with perfume hits at different points during the laundry process. It is particularly preferred that the fabric conditioners of the present invention comprise a combination of both free perfume and perfume microcapsules.

Preferably the fabric conditioners of the present invention preferably comprise 0.1 to 15 wt. % perfume materials, more preferably 0.5 to 10 wt. % perfume materials, most preferably 1 to 10 wt. % perfume materials.

Useful perfume components may include materials of both natural and synthetic origin. They include single compounds and mixtures. Specific examples of such components may be found in the current literature, e.g., in Fenaroli's Handbook of Flavor Ingredients, 1975, CRC Press; Synthetic Food Adjuncts, 1947 by M. B. Jacobs, edited by Van Nostrand; or Perfume and Flavor Chemicals by S. Arctander 1969, Montclair, N.J. (USA).

These substances are well known to the person skilled in the art of perfuming, flavouring, and/or aromatizing consumer products.

### Free Perfumes

The fabric conditioners of the present invention preferably comprise 0.05 to 10 wt. % free perfume, more preferably 0.1 to 8 wt. % free perfume.

Particularly preferred perfume components are blooming perfume components and substantive perfume components. Blooming perfume components are defined by a boiling point less than 250° C. and a LogP or greater than 2.5. Substantive perfume components are defined by a boiling point greater than 250° C. and a LogP greater than 2.5. Boiling point is measured at standard pressure (760 mm Hg). Preferably a perfume composition will comprise a mixture of blooming and substantive perfume components. The perfume composition may comprise other perfume components.

It is commonplace for a plurality of perfume components to be present in a free oil perfume composition. In the compositions for use in the present invention it is envisaged that there will be three or more, preferably four or more, more preferably five or more, most preferably six or more different perfume components. An upper limit of 300 perfume components may be applied.

### Perfume Microcapsules

The fabric conditioner compositions of the present invention preferably comprise 0.05 to 10 wt. % perfume microcapsules, more preferably 0.1 to 8 wt. % perfume microcapsules. The weight of microcapsules is of the material as supplied.

When perfume components are encapsulated, suitable encapsulating materials, may comprise, but are not limited to; aminoplasts, proteins, polyurethanes, polyacrylates, polymethacrylates, polysaccharides, polyamides, polyolefins, gums, silicones, lipids, modified cellulose, polyphosphate, polystyrene, polyesters or combinations thereof. Particularly preferred materials are aminoplast microcapsules, such as melamine formaldehyde or urea formaldehyde microcapsules.

Perfume microcapsules of the present invention can be friable microcapsules and/or moisture activated microcapsules. By friable, it is meant that the perfume microcapsule will rupture when a force is exerted. By moisture activated, it is meant that the perfume is released in the presence of water. The fabric conditioners of the present invention preferably comprise friable microcapsules. Moisture activated microcapsules may additionally be present. Examples of a microcapsules which can be friable include aminoplast microcapsules.

Perfume components contained in a microcapsule may comprise odiferous materials and/or pro-fragrance materials.

Particularly preferred perfume components contained in a microcapsule as described above.

The microcapsules may comprise perfume components and a carrier for the perfume ingredients, such as zeolites or cyclodextrins.

### Additional Ingredients

The compositions may comprise other ingredients of fabric conditioner liquids as will be known to the person skilled in the art. Among such materials there may be mentioned: thickening polymers, co-softeners, fatty complexing agent, antifoams, insect repellents, shading or hueing dyes, preservatives (e.g. bactericides), pH buffering agents, perfume carriers, hydrotropes, anti-redeposition agents, soil-release agents, polyelectrolytes, anti-shrinking agents, anti-wrinkle agents, anti-oxidants, dyes, colorants, sunscreens, anti-corrosion agents, drape imparting agents, anti-static agents, sequestrants and ironing aids. The products of the invention may contain pearlisers and/or opacifiers. A preferred sequestrant is HEDP, an abbreviation for Etidronic acid or 1-hydroxyethane 1,1-diphosphonic acid.

Particularly preferred additional ingredients are thickening polymers. The fabric conditioners comprise fatty complexing agents. Preferred fatty complexing agents include fatty alcohols and fatty acids, of these, fatty alcohols are most preferred. Preferred thickening polymers are cationic polymers, in particular cross linked cationic polymers.

### Use of the Fabric Conditioner

The fabric conditioners described herein may provide various benefits for the consumer. In one aspect of the present invention is provided the use of a fabric conditioner as described herein to provide; colour care, maintaining whites, stain protection or a combination thereof. Preferably the fabric conditioners are used in five consecutive laundry cycles, more preferably ten consecutive laundry cycles, more preferably 15 consecutive cycles.

Colour care is defined as maintaining the original colour of a fabric through the laundry process. This may also be described as preventing or reducing colour fade. Colour care can be measured using CIELAB colour space also referred to as L*a*b*. Colour care may also be referred to as anti-aging.

Maintaining whites is defined as reducing the greying of whites during the laundry process. As with colour care, this can be measured using CIELAB colour space also referred to as L*a*b*.

Stain protection is defined as prevention of permanent stains. The fabric conditioners described herein enable easier removal of stains wherein the fabric has previously been treated with the fabric conditioner.

In addition to the colour care, maintaining whites and stain removal benefits, the fabric conditioners described herein also provide a malodor benefit, i.e. a reduction in malodors.

### Method

In one aspect of the present invention is provided a method of protecting fabrics from permanent staining, wherein the method comprises the steps of:
i. Treating the fabric with a fabric conditioner composition as described herein in the rinse stage of a laundry process;
ii. Using the fabric; and
iii. Washing the fabric with a laundry detergent.

The fabric may be dried between steps i. and ii. Drying may be line drying or using a tumble drier.

Preferably the method is repeated for 5 consecutive laundry cycles, more preferably, most preferably 15. This leads to enhanced stain protection benefits. Stain protection is defined as prevention of permanent stains. The method described herein enables easier removal of stains when a stain occurs during use of a fabric.

Step i. involves treating the fabric with a fabric conditioner composition comprising a soil release polymer. This step may take place either while hand washing or using a washing machine. Preferably the clothes are treated with a 10 to 100 ml dose of a fabric conditioner as described herein, for a 2 to 7 kg load of clothes. More preferably, 10 to 80 ml for a 2 to 7 kg load of clothes.

Step ii. involves using the fabric. For example, if the fabrics are clothes, wearing the clothes. The fabrics may be used until the user deems it necersary to launder the fabrics again.

Step iii. involves washing the fabric with a laundry detergent. The laundry detergent is preferably a laundry detergent as described below. This step may take place either while hand washing or using a washing machine.

The term “laundry detergent” in the context of the method described herein denotes formulated compositions intended for and capable of wetting and cleaning domestic laundry such as clothing, linens and other household textiles. The laundry detergent may be a liquid or solid composition.

In a preferred embodiment the laundry detergent is a liquid composition. Preferably the liquid composition is isotropic. Pourable liquid detergent compositions preferably have a viscosity of from 200 to 1,500 mPa·s, preferably from 200 to 700 mPa·s.

Preferably, the composition has a pH of 5 to 10, more preferably 6 to 8, most preferably 6.1 to 7.0.

The detergent composition preferably comprises from 5 to 60% and preferably from 10 to 40% (by weight based on the total weight of the composition) of one or more detersive surfactants. The term “detersive surfactant” in the context of this invention denotes a surfactant which provides a detersive (i.e., cleaning) effect to laundry treated as part of a domestic laundering process. “detersive surfactants” include anionic and non-ionic surfactants.

Suitable non-soap anionic-surfactants for use in laundry detergents as described herein are typically salts of organic sulfates and sulfonates having alkyl radicals containing from about 8 to about 22 carbon atoms, the term “alkyl” being used to include the alkyl portion of higher acyl radicals. Examples of such materials include alkyl sulfates, alkyl ether sulfates, alkaryl sulfonates, alpha-olefin sulfonates and mixtures thereof. The alkyl radicals preferably contain from 10 to 18 carbon atoms and may be unsaturated. The alkyl ether sulfates may contain from one to ten ethylene oxide or propylene oxide units per molecule, and preferably contain one to three ethylene oxide units per molecule. The counterion for anionic surfactants is generally an alkali metal such as sodium or potassium; or an ammoniacal counterion such as monoethanolamine, (MEA) diethanolamine (DEA) or triethanolamine (TEA). Mixtures of such counterions may also be employed. Sodium and potassium are preferred.

Suitable anionic surfactants include; alkylbenzene sulfonates, particularly linear alkylbenzene sulfonates (LAS) with an alkyl chain length of from 10 to 18 carbon atoms; linear alkyl benezene (LAB); alkyl sulfate surfactant (e.g. PAS), such as non-ethoxylated primary and secondary alkyl sulphates with an alkyl chain length of from 10 to 18; alkyl ether sulfates having a straight or branched chain alkyl group having 10 to 18, and containing an average of 1 to 3EO units per molecule (e.g. SLES); C16/18 alkyl ether sulphates; and mixtures thereof.

Preferred anionic surfactants are selected from: linear alkyl benezene sulphonates, sodium lauryl ether sulphonates with 1 to 3 moles (average) of ethoxylation, primary alkyl sulphonates, methyl ether sulphates and secondary alkyl sulphonates or mixtures thereof. A preferred mixture of anionic surfactants for use in the invention comprises linear alkylbenzene sulfonate (preferably C11 to C15 linear alkyl benzene sulfonate) and sodium lauryl ether sulfate. (preferably C10 to C18 alkyl sulfate ethoxylated with an average of 1 to 3 EO).

Suitable non-ionic surfactants include C16/18 alcohol ethoxylates; polyoxyalkylene compounds, i.e. the reaction product of alkylene oxides (such as ethylene oxide or propylene oxide or mixtures thereof) with starter molecules having a hydrophobic group and a reactive hydrogen atom which is reactive with the alkylene oxide; aliphatic C8 to C18, more preferably C12 to C15 primary linear alcohol ethoxylates with an avrage of from 3 to 20, more preferably from 5 to 10 moles of ethylene oxide per mole of alcohol; and mixtures thereof.

A preferred non-ionic surfactant are the C16/18 Alcohol ethoxylates having the formula:

R₁—O—(CH₂CH₂O)_{q}—H

where R₁ is selected from saturated, monounsaturated and polyunsaturated linear C16 and C18 alkyl chains and where q is from 4 to 20, preferably 5 to 14, more preferably 8 to 12.

The detersive surfactants are preferably present in a ratio of detersive surfactant to fabric on a weight to weight basis of from 1:50 to 1:750, preferably 1:100 to 1:600, more preferably 1:150 to 1:500.

The laundry detergents for use in the method described herein may comprise additional ingredients, such as: ethoxylated glycerol esters (comprising an ethoxy group ether bound to each on the hydroxy groups of the glycerol, wherein one, two or three of these ethoxy groups is esterified with a fatty acid), antifoam, preservatives, flourescers, polymeric cleaning boosters such as alkoxylated polyethyleneimines, hydrotropes, co-solvents, phase stabilizers, co-surfactants (such as amphoteric (zwitterionic) and/or cationic surfactants), builders and sequestrants, polymeric thickeners, shading dyes, external structurants (such as include hydrogenated castor oil, microfibrous cellulose and citrus pulp fibre), enzymes, fragrances, microcapsules, foam boosting agents, polyelectrolytes, anti-shrinking agents, anti-wrinkle agents, anti-oxidants, sunscreens, anti-corrosion agents, drape imparting agents, anti-static agents, ironing aids, colorants, pearlisers and/or opacifiers, and shading dye.

Preferably the laundry detergent composition is free from soil release polymers.

### EXAMPLES

Example compositions of a fabric conditioner composition as described herein and a laundry detergent suitable for use in the method described herein.

TABLE 1
Fabric conditioner

| | wt. % active |
|---|---|
| Fabric softening active¹ | 4.5 |
| Fatty alcohol² | 0.5 |
| Soil release polymer³ | 0.5 |
| Polymer⁴ | 0.2 |
| Free perfume | 1.7 |
| Perfume microcapsule | 0.17 |
| Minors (pH adjuster, | <1 |
| preservative, anti foam, etc.) | |
| Water | To 100 |

Fabric softening active¹ - Dialkyloxyethyl Hydroxyethyl Methyl Ammonium Methyl sulphate
Fatty alcohol² - Cetyl/Stearyl Alcohol
Soil release polymer³ - Texcare SRN 300
Polymer⁴ - Copolymer of acrylamide and dimethylaminoethyl methacrylate

TABLE 2
Laundry detergent

| | wt. % active |
|---|---|
| Lauryl alkyl sodium sulfonate | 3 |
| Sodium lauryl ether sulphate 3EO | 7 |
| Cocamidopropyl betaine | 0.8 |
| Sodium hydroxide | 0.3 |
| Triethanolamine | 0.6 |
| Ethoxylated polyethylineimine | 0.7500 |
| Sodium chloride | 2 |
| Enzymes | <0.5 |
| Pefume | 0.2 |
| Minors | <1 |
| Water | To 100 |

### Wash Experiment

The effectiveness of different levels of fabric softening active was assessed of five different types of fabric.

TABLE 3
Fabric conditioner compositions

| | wt. % active | | |
|---|---|---|---|
| | A | B | 1 |
| Fabric softening active¹ | 8 | 8 | 6.5 |
| Soil release polymer² | — | 0.8 | 0.8 |
| Fatty alcohol³ | — | — | 0.5 |
| Free perfume | 1.95 | 1.95 | 1.95 |
| Encapsulated perfume | 0.35 | 0.35 | 0.5 |
| Polymer⁴ | 0.2 | 0.2 | 0.2 |
| Minors (pH adjuster, | <1 | <1 | <1 |
| preservative, anti foam, etc.) | | | |
| Water | To 100 | To 100 | To 100 |

Fabric softening active¹ - Dialkyloxyethyl Hydroxyethyl Methyl Ammonium Methyl sulphate
Soil release polymer² - Texcare SRN 300
Fatty alcohol³ - Cetyl/Stearyl Alcohol
Polymer⁴ - Copolymer of acrylamide and dimethylaminoethyl methacrylate

The fabric conditioners were prepared using the following method. Water was heated in a vessel to ˜45° C., and the perfume microcapsules dispersed therein. The minors were added with stirring. A premix of fabric softening active and fatty alcohol (where present) was prepared by heating the ingredients to a temperature of ˜65° C. The premix was added to the main mix vessel with stirring. The cationic polymer was added with stirring. The composition was cooled to ˜35° C. and the free perfume was added with stirring, followed by the soil release polymer.

5 different fabrics were assessed, each was washed with compositions A, B or 1 fifteen times.

In each wash, the fabrics were washed with 74 g of Omo laundry powder detergent, and in the rinse the fabrics were treated with 22 g of a fabric conditioner (A, B or 1).

Into each wash was added a fresh soiled fabric. The fabric was soiled with sebum and general soils. The same amount of soiling was added into each wash. Additionally, a ballast of knitted cotton and kitted polyester were used to make a total wash load of 2.24 kg.

Soiling was measured using a spectrometer and the Ganz whiteness scale. The spectrometer was calibrated with a “pure” white sample. Measurements were taken after 5, 10 and 15 washes and an average result calculated for each fabric with the different compositions. The fabric conditioner comprising no SRP (composition A) was used as a baseline for the colour assessment. Fabrics treated with compositions B and 1 were compared to the baseline. The difference between the baseline (composition A) and compositions B and 1 are reported in table 4. A negative number indicates a worse performance than the baseline (composition A), a positive number indicates an improvement in soil deposition compared to the baseline (composition A).

TABLE 4
Results

| | Difference compared to fabric conditioner | | | | | |
|---|---|---|---|---|---|---|
| | with no SRP | | | | | |
| | 5 washes | | 10 washes | | 15 washes | |
| Fabric | B | 1 | B | 1 | B | 1 |
| Woven cotton | −0.36 | −0.34 | 0.75 | 3.84 | 1.78 | 5.24 |
| Knitted cotton | −0.15 | 0.4 | 1.25 | 3.55 | 0.81 | 7.03 |
| Woven polycotton | 0.59 | 1.1 | 2.41 | 2.56 | 3.06 | 5.78 |
| Woven polyester | −0.61 | 0.09 | 2.77 | 2.82 | 2.85 | 5.05 |
| Knitted Nylon | −3.13 | −0.82 | −1.77 | 1.77 | −0.35 | 3.6 |

For all fabrics, fabric conditioner 1 provided superior whitening i.e. less deposited soil, compared to composition 1.

1-14. (canceled)

15. A fabric conditioner formulation comprising:
a) 2 to 7.5 wt. % of quaternary ammonium compound;
b) 0.2 to 2 wt. % of Soil release polymer;
c) perfume microcapsules; and
d) fatty complexing agent;
wherein the soil release polymer has the formula: 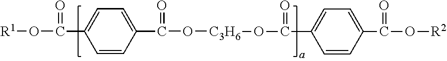
wherein
R¹ and R² are independently of one another are X—(OC₂H₄)ₙ—(OC₃H₆)ₘ
wherein X is C1-4 alkyl, the —(OC₂H₄) groups and the —(OC₃H₆) groups are arranged blockwise and the block consisting of the —(OC₃H₆) groups is bound to a COO group or are HO—(C₃H₆);
n is based on a molar average a number from 12 to 120;
m is based on a molar average a number from 1 to 10; and
a is based on a molar average a number from 4 to 9.

16. The fabric softening formulation according to claim 15, wherein the fabric softening active is an ester linked quaternary ammonium compound.

17. The fabric softening formulation according to claim 15, wherein the soil release polymer is selected from the group consisting of co-polyesters, cellulosic derivatives, polymers with poly(vinyl ester) hydrophobic segments, polyester-polyamide polymers and combinations thereof.

18. The fabric softening formulation according to claim 15, wherein the composition comprises free perfume.

19. The fabric softening formulation according to claim 15, wherein the fatty complexing agent is selected from fatty alcohols and/or fatty acids.

20. A method of protecting fabrics from permanent staining, wherein the method comprises the steps of:
i. treating the fabric with a composition according to claim 15 in a rinse stage of a laundry process;
ii. using the fabric; and
iii. washing the fabric with a laundry detergent.

21. The method according to claim 20, wherein the method is repeated in 5 consecutive laundry cycles.

22. The method according to claim 20, wherein the laundry detergent is free from soil release polymers.

23. The method according to claim 20 wherein the method provides colour care, white color maintenance, stain protection or a combination thereof to the fabric being treated.

24. The method according to claim 20 wherein the composition further comprises insect repellent, shading dye, hueing dye, pearlizer, antiwrinkle agent, sunscreen or a mixture thereof.
